(19) United States
(12) Patent Application Publication
(10) Pub. No.: US 2011/0309656 A1
(43) Pub. Date: Dec. 22, 2011

(54) Modular roof assembly

(76) Inventors: Brian Buda, Brighton, MI (US); Robert Moore, Salisbury, NC (US)

(21) Appl. No.: 12/998,400

(22) PCT Filed: Oct. 16, 2009
(86) PCT No.: PCT/CA2009/001488

§ 371 Date: Aug. 15, 2011

(30) Foreign Application Priority Data
Oct. 16, 2008 (US) 61/136947

(51) Int. Cl. B62D 33/06; B29C 33/30

(52) U.S. Cl. 296/190.02; 425/182

(57) ABSTRACT

A modular roof assembly has a front outer panel, a rear outer panel and a top outer panel connected to and extending between said front outer panel and said rear outer panel. At least two side outer panels extend between and connect to front outer panel, rear outer panel and the top outer panel to form at least two closed sides of said modular roof assembly. A channel is formed by a gap between portions of the top outer panel and the rear outer panel for proving a support to the modular roof assembly. The modular roof assembly is made of composite material and is configured to be connected to a sleeper cab.

### CROSS-REFERENCE TO RELATED APPLICATIONS

This application claims the benefit of U.S. Provisional Application No. 61/136,947 filed Oct. 16, 2008, the disclosure of which is incorporated herein by reference in its entirety.

### TECHNICAL FIELD

The present invention relates to a modular roof assembly for a truck sleeping cab.

### BACKGROUND OF THE INVENTION

In the field of cab design for heavy trucks, there has been a need to design cabs that are lighter with simpler construction but provided several options in terms of cab parameters such as height, length, width, volume or area. There is a need for manufacturers of such cabs to diversifying the number of cab parameters available, while not having to have more tools and equipment to produce such a variety. Thus there is a need to be able to produce a variety of different sized cabs using the same tooling. Additionally in the past cans have utilized heavy metal frames and inner support panels for supporting composite outer panels. It is desirable to form new ways of manufacturing cans that are constructed of lighter materials and require fewer components.

It would be advantageous to provide a modular sleeper cab assembly for use within vehicles, such as class 8 trucks. It would also be advantageous to provide a sleeper cab assembly that is relatively simple and inexpensive to manufacture. It would further be advantageous to provide a modular sleeper cab assembly that may be tailored to particular dimensions for a desired application without requiring new manufacturing equipment for each application configuration. It would be desirable to provide a sleeper cab assembly that includes any one or more of these or other advantageous features as may be apparent from the description provided herein.

### SUMMARY OF THE INVENTION

A modular roof assembly for a sleeper cab. The modular roof assembly has a front outer panel, a rear outer panel and a top outer panel connected to and extending between the front outer panel and the rear outer panel. At least two side outer panels extend between and connect to front outer panel, rear outer panel and the top outer panel to form at least two closed sides of the modular roof assembly. A channel is formed by a gap between portions of the top outer panel and the rear outer panel for proving a support to the modular roof assembly. The modular roof assembly is made of composite material and is configured to be connected to a sleeper cab.

Another embodiment of the invention relates to a modular sleeper cab system where the components of the sleeper can are interchangeable with other alternate components having a different parameter. A given component and its alternate component are made on the same moulding tool, which has different inserts that control the parameters of the part being moulded.

The present application relates generally to the field of cab construction for use on vehicles such as heavy duty trucks (e.g., “class 8” trucks). The present application relates to a sleeper cab or sleeper box for use with such vehicles that is relatively simple to manufacture and that may be tailored to accommodate different vehicle requirements and parameters (e.g., length, width, or height). The present invention seeks to improve on previous systems by providing a modular sleeper cab system that allows manufacturers to supply sleeper cabs having various parameters off of the same tool system. A modular roof is provided that allows roofs of various sizes to be produced from the same tool using inserts. Additionally the present invention provides improved sleeper cabs made from composite materials having structural grooves that eliminate the needs for additional supporting structures while providing a significant weight reduction to the overall sleeper cab design.

### BRIEF DESCRIPTION OF THE DRAWINGS

FIG. 1 is a perspective view of a vehicle according to an exemplary embodiment.

FIG. 2 is a partially exploded perspective view of an exemplary embodiment of a modular sleeper cab assembly and other vehicle components, for use within a vehicle, such as the vehicle shown in FIG. 1.

FIG. 3 is a partially exploded perspective view of a modular sleeper cab assembly according to another exemplary embodiment.

FIG. 3B is a partially exploded perspective view of a modular sleeper cab assembly according to another exemplary embodiment.

FIG. 4 is a perspective view of an exemplary roof assembly illustrating its dimensional flexibility.

FIG. 5A is an exploded perspective view of an exemplary embodiment of a roof assembly.

FIGS. 5B-5G are cross-sectional views of various components shown in FIG. 41.

FIGS. 6 and 7 are sectional views of a portion of a modular roof assembly according to an exemplary embodiment.

FIG. 8 shows an exemplary design of a rib section used for hard mounting panels together for permanent attachment.

FIG. 9 is a perspective view of a roof panel according to an exemplary embodiment and

FIGS. 10-12 are side views of inserts for tooling used to construct exemplary embodiments of modular roof panels according to various exemplary embodiments.

### DETAILED DESCRIPTION OF THE PREFERRED EMBODIMENTS

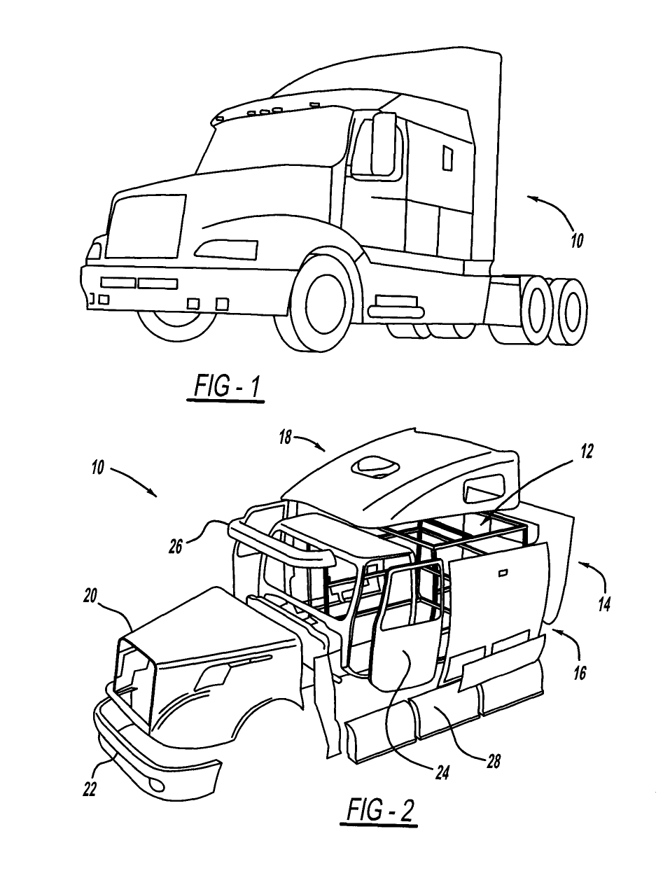

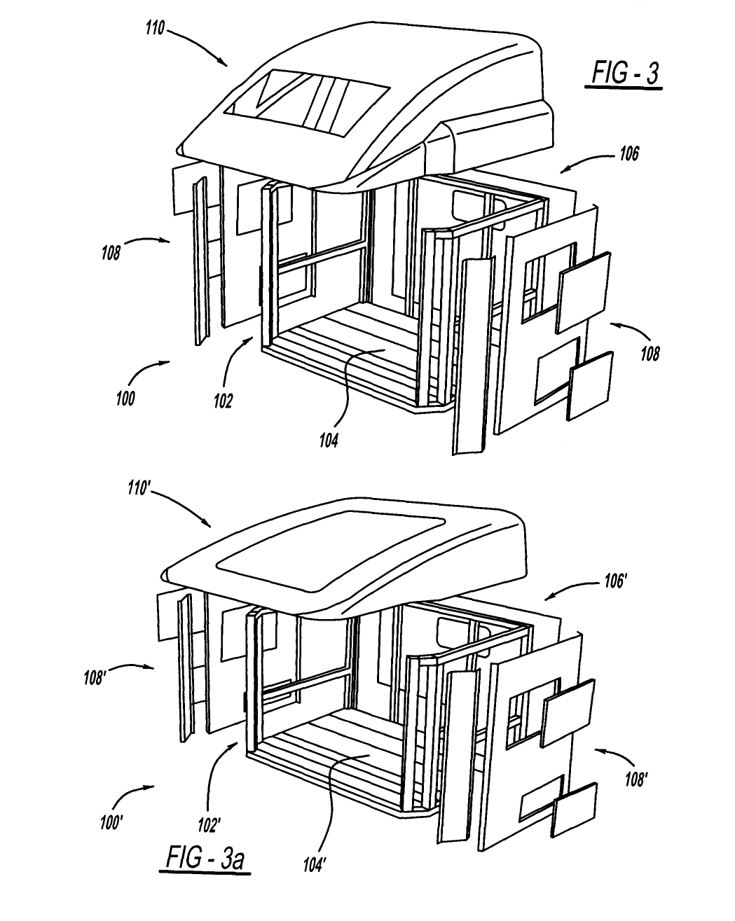

Referring to FIG. 2, an exemplary embodiment of a modular sleeper cab assembly 10 is illustrated, and includes a frame structure 12, a back assembly 14, at least one side assembly 16, and a roof assembly 18. The modular sleeper cab assembly 10 may further include a hood panel 20, a bumper panel 22, one or more door panels 24, a windshield panel 26 (e.g., a visor), and a step 28. The rear portion of the modular sleeper cab assembly 10 is commonly referred to as a sleeper box, while the forward portion of the sleeper cab assembly 10 is a passenger compartment, and includes a driver's seat and passenger seat (not shown). The disclosed constructions of modular sleeper cab assemblies may additionally be used for constructing modular “day cab” assemblies, which are heavy duty trucks without the (rear) sleeper portion. Although FIG. 2 illustrates and the present application describes the use of modular sleeper cab assembly 10 with a heavy duty truck 10, such as a class 8 truck shown in FIG. 1, structures similar to the sleeper cab assembly 10 may be used with other types of vehicles as well (e.g., buses, passenger cars, class 6 trucks, other utility trucks or vans, recreational vehicles, aerospace applications, or marine vehicles such as boats and the like).

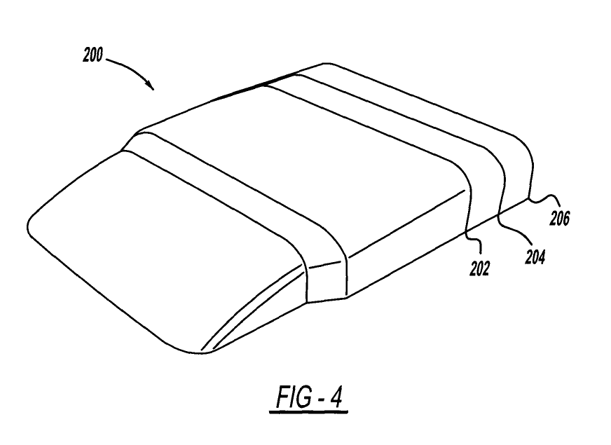

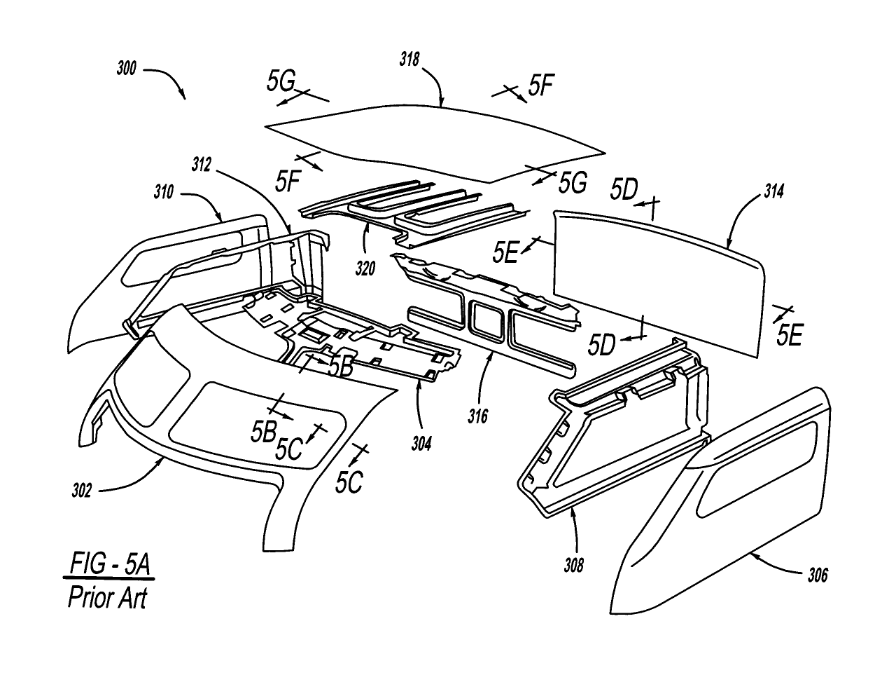

Referring to FIG. 3, another exemplary embodiment of a modular sleeper cab assembly 100 is illustrated, and includes a frame structure 102, a floor assembly 104, a back assembly 106, two side assemblies 108, and a roof assembly 110. The sleeper cab assembly 100 is constructed by coupling the frame structure 102 to the floor assembly 104, then the side assemblies 108, back assembly 106, and roof assembly 110 may be coupled to the frame structure 102. The assembly in FIG. 3 illustrates only the sleeper box portion of the sleeper cab assembly and an associated roof assembly. It should be understood that the sleeper box portion shown in FIG. 3 may be used in conjunction with a separate passenger compartment to form a complete sleeper cab assembly according to other exemplary embodiments.

It should be understood to those reviewing the present disclosure that additional components may be secured to the various components of the assemblies shown in FIGS. 2-3, including, for example, seats, storage compartments, beds, dashboard assemblies, doors, engine compartment components, and a variety of other components that would be included in the interior of a sleeper cab assembly as are well known in the art.

The various components of the assemblies shown in FIGS. 2-3 may be coupled together using any of a variety of suitable methods, such as mechanical fastening methods (e.g., rivets or screws), chemical fastening (e.g., adhesives), other fastening methods (e.g., ultrasonic, laser, or hot gas welding), or any combination of fastening methods.

FIG. 3A also shows interchangeable alternate components such as a frame structure 102′, two side assemblies 108′ and roof assembly 110′. The difference is that the interchangeable alternate components have different parameters, which as shown, have a lower height and length. Each of these individual alternate components and their equivalent components that include the frame structure 102, two side assemblies 108 and roof assembly 110 are formed in a single respective compression mould tool that utilizes inserts that allow parts of different sizes to be formed on the same tool. The alternate components, their counterparts, mould tools and their inserts provide a modular sleeper cab system where different size sleeper cabs can be assembled using the same tool.

According to an exemplary embodiment, a modular roof assembly may also be utilized in conjunction with any of the assemblies described above. An exemplary embodiment of the modular roof assembly comprises a front outer panel, a front inner panel, right side outer panel, right side inner panel, a left side outer panel, a left side inner panel, a rear outer panel, a rear inner panel, a top outer panel and a top inner panel. An exemplary modular roof assembly is constructed using multiple members of varying cross section and length made from a composite material, such as a resin reinforced by a fiber (e.g. polyurethane reinforced by fiberglass), preferably manufactured through a compression moulded process. The use of composite materials manufactured through the compression moulding process leads to durable and high strength components which are light weight and less expensive than traditional steel components. These compression moulded components offer protection from chemical reactions (e.g. oxidation) which is problematic to steel parts. Additionally, a modular compression moulded roof assembly offers improved acoustic properties by reducing the exterior noise level inside the sleeper box. An exemplary modular roof assembly's members may be joined using any combination of mechanical fastening (e.g. rivets or self tapping screws), chemical fastening (e.g. adhesives), or other fastening (e.g. welding techniques such as ultrasonic or hot gas).

An exemplary embodiment of a modular compression moulded roof assembly is geometrically flexible, with the ability to modify its length, width, or height to accommodate changing customer dimensions. Additionally, multiple modular roof assemblies use the same compression moulded front and rear members and incorporate different side members to compensate for length variations, or use the same compression moulded side members and incorporate different front and rear members to compensate for width variations.

A modular roof assembly incorporates inner panels which are designed to maximize strength properties, by increasing the member's moment of inertia, while keeping mass down. The outer panels of the modular roof assembly are designed primarily for aesthetic purposes per customer requirements but may incorporate supports or ribs to improve strength and are typically joined to the inner panels. In one embodiment, both the inner and outer panels are constructed of one piece panels or alternatively constructed of multiple panels joined together using any combination of mechanical fastening (e.g. rivets or self tapping screws), chemical fastening (e.g. adhesives), or other fastening (e.g. welding techniques such as ultrasonic or hot gas).

An alternative embodiment of a modular roof assembly incorporates the use of laminated or non-laminated EPP, expanded polypropylene, foam between the inner and outer panels of the roof assembly to enhance the thermal and acoustic properties of the sleeper box. The laminated EPP foam may also be used to fill the hollow portions of the varying cross sections of the inner panels or in other useful locations. According to other embodiments, other foams and materials are used to enhance the thermal and acoustic properties of a modular roof assembly.

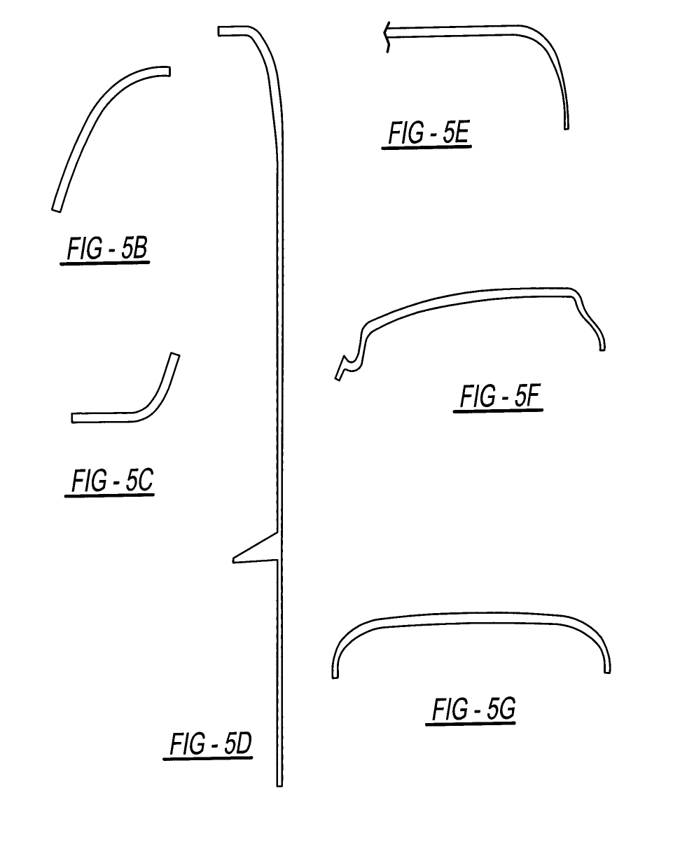

Referring to FIG. 4, an exemplary outer panel of a roof assembly 200 is shown according to an exemplary embodiment illustrating the dimensional flexibility of the compression moulded manufacturing process that is used to manufacture specific components of the roof assembly. Using this process, roof assembly 200 may be formed to a variety of lengths. For example, according to a first exemplary embodiment, the roof assembly has a first rear edge as indicated with reference numeral 202. According to another exemplary embodiment, the roof assembly includes a second rear edge 204 that is part of a roof assembly that is longer and a even longer roof assembly having a third rear edge 206 is possible. The roof assembly 200 is moulded using a tool with various inserts, which are described further below. However, the use of the mould tool and inserts allows many different lengths of roof assemblies 200 to be manufactured using the same tool and different inserts.

The dimensional flexibility of the roof assembly is achieved by using different inserts in the core or cavity halves of a mould used to form the roof assembly. Such a process acts to reduce piece cost and tooling cost. The dimensional flexibility is not limited to lengths as illustrated in FIG. 4, but may allow for variations in width, height, thickness, or any combination thereof by using inserts in different portions of a mould. In this manner, the need to purchase different moulds for each different roof assembly having varying dimensions may be eliminated, thus providing potentially significant tooling cost savings. The flexibility of a modular roof assembly is not limited to its dimensional properties as its geometry may be varied to provide for inclusion of or attachment of other features and components. The roof assembly may be constructed using a one-piece panel with no panel openings, as illustrated. According to other embodiments, roof assemblies may be constructed using multiple panels and may incorporate panel openings.

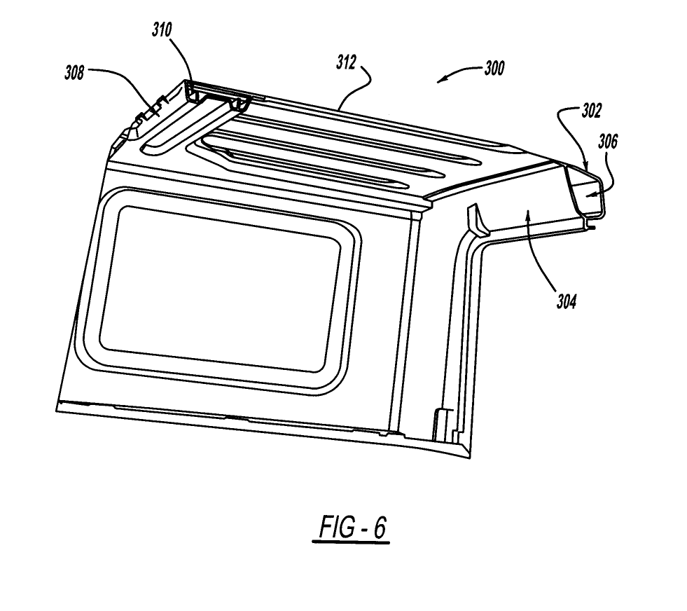

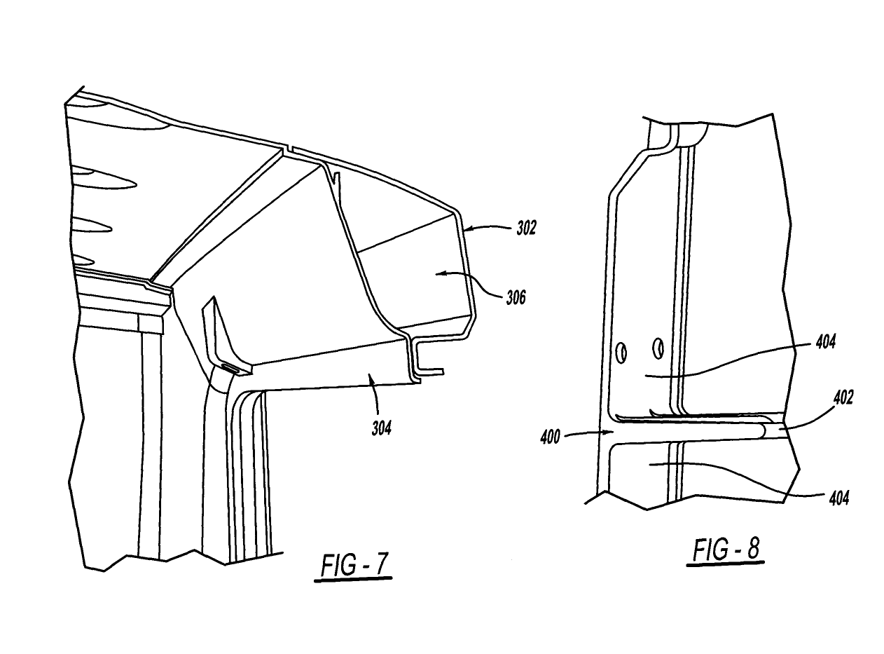

Referring to FIG. 5A, an exemplary embodiment of a modular roof assembly 300 is illustrated in an exploded manner and comprises of a front outer panel 302, a front inner panel 304, a right side outer panel 306, a right side inner panel 308, a left side outer panel 310, a left side inner panel 312, a rear outer panel 314, a rear inner panel 316, a top outer panel 318 and a top inner panel 320. Cross-sectional view of various components are shown in FIGS. 5B-5G.

According to other embodiments, a modular roof assembly may include any combination of panels. The panels comprising a modular roof assembly are constructed using multiple members of varying cross section and length made from a composite material, such as a resin reinforced by a fiber (e.g. polyurethane reinforced by fiberglass), preferably manufactured through a pultrusion process. The panels comprising a modular roof assembly may be joined together using any combination of mechanical fastening (e.g. rivets or self tapping screws), chemical fastening (e.g. adhesives), or other fastening (e.g. welding techniques such as ultrasonic or hot gas). Components 302, 306, 310, 314, 318 are moulded to varying dimensions by placing inserts in the mould cavity used to form such components according to an exemplary embodiment.

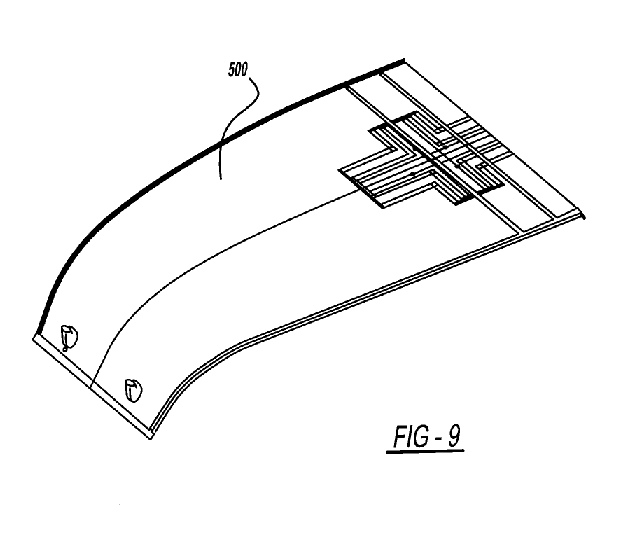

Exemplary panels for a modular roof assembly are coupled with other panels or support components to increase the structural rigidity of the assembly by increasing the design properties (e.g., moment of inertia) through the use of improved geometries, such as closed sections and strengthening ribs. These closed sections may be filled with a foam (e.g., EPP) or other useful material to enhance the thermal and acoustic properties of the assembly. This can also be used to form relatively complex geometries by combining relatively simple components together. For example, as shown in FIGS. 6 and 7, a roof assembly 300 includes a first panel 302 intended to provide an outer surface for the roof assembly 300 that is coupled to a second panel 304 that forms a rear outer panel of the roof assembly 300. A space or channel 306 is formed between the two panels, and may be filled with foam or another material or remain empty. The upper panel 312 is connected has a space or roof bows 310 (which again may be empty or filled with foam or another suitable material) that extend across the inner surface of the upper panel 312 between the sides of the roof assembly 300 in order to provide further support to the roof assembly 300. The roof bows 310 and the channel 306 eliminate the need to have inner panels 304, 308, 312, 316, 320 shown in FIG. 4. The hollow construction of the various frame structure members including channel 306 and roof bows 310 may serve additional purpose, for example, these members may serve as HVAC carrying members to transport heated or cooled air into the sleeper cab assembly, or may also serve as routing and protection of wiring harnesses.

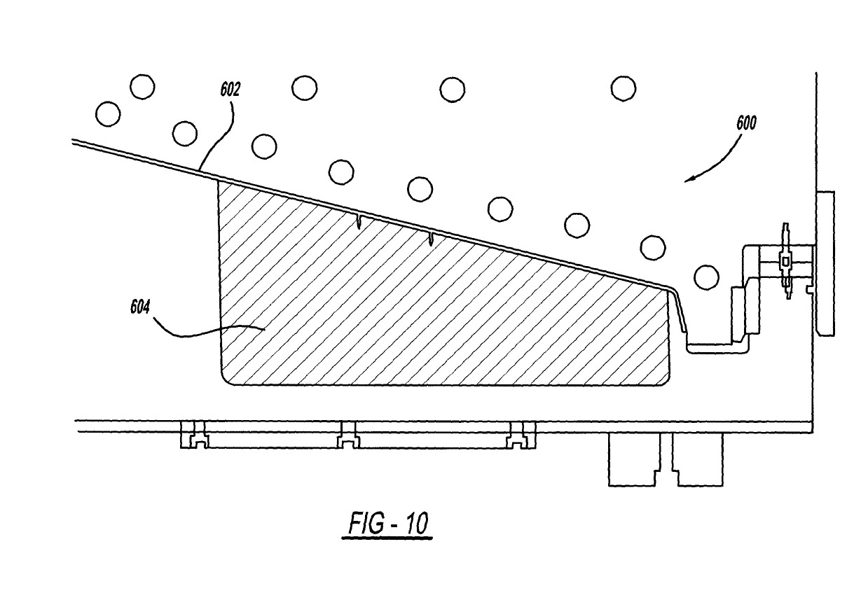

FIG. 8 shows an exemplary design of a rib section used for hard mounting panels together for permanent attachment. A rib 400 extends into one or more grooves 402 in panels 404 for mounting the panels 404 together. The panels 404 can be the any of the panel described in the figures in this application. In another embodiment of the invention a modular roof assembly uses five or more sets of grooves for all of the panels of the modular roof assembly. Each one of the five or more sets is positioned at the attachment point or points of the front outer panel and the top outer panel, the rear outer panel and the top outer panel, the side outer panel and the top outer panel, front outer panel and rear outer panels.

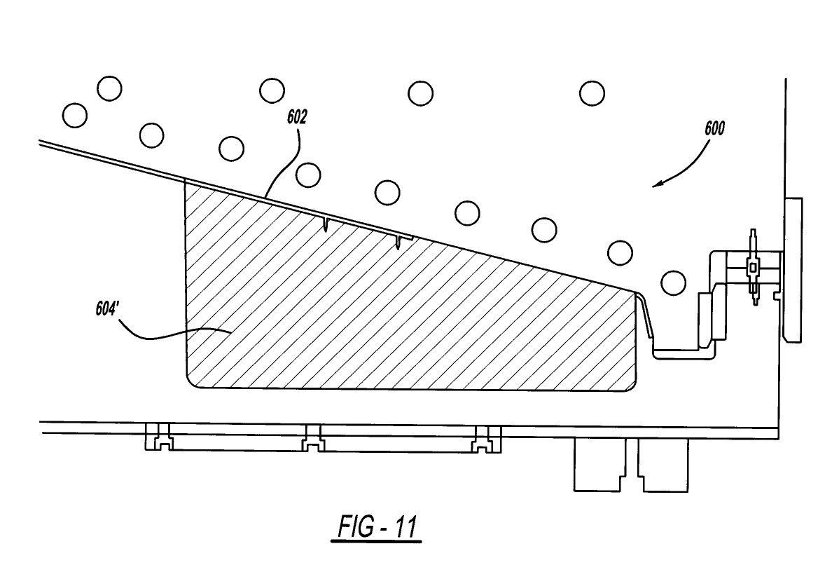

Referring to FIG. 9, an exemplary embodiment of a roof panel 500 for constructing a roof assembly is illustrated. An exemplary roof panel is constructed to incorporate one or more of the panels (e.g., top outer panel, rear outer panel, front outer panel) of the roof assembly into a one piece construction. Different exemplary embodiments are made from the same base tool using tooling inserts to produce low cost embodiments with varying dimensional parameters (e.g., length, width). The use of tooling inserts allows for low cost flexibility, with quick change over times, to produce multiple variants of a similar design to accommodate different customer requirements.

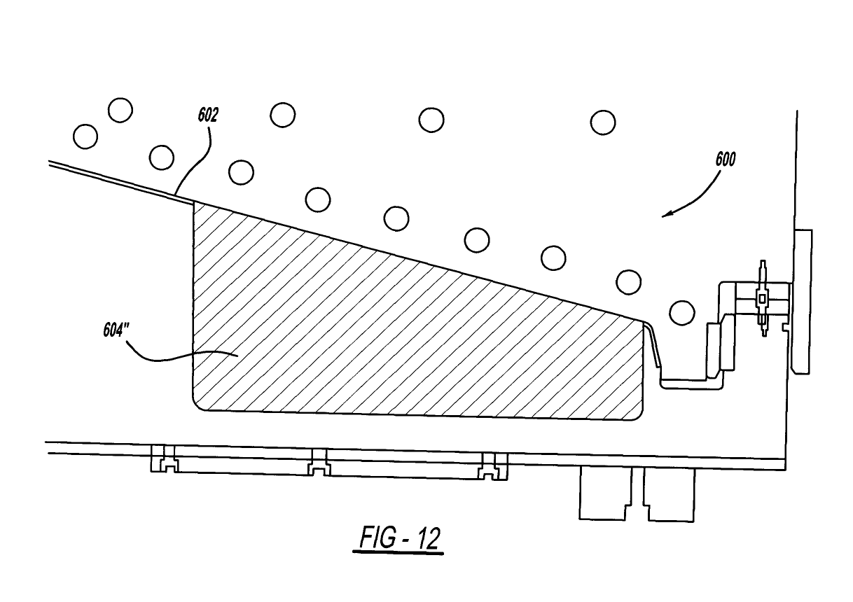

Referring to FIGS. 10-12, exemplary embodiments of a moulding tool 600 having a cavity 602 and different tooling inserts 604, 604′, 604″ for use in constructing dimensionally varying embodiments of the roof panel of FIG. 9. FIG. 10 shows the core insert 604 tooling that may be used to construct a roof panel with a length of 72″, while FIG. 11 shows an insert 604′ that constructs a roof panel with the length of 60″. FIG. 12 shows an insert 604″ that shows a core insert that may be used to construct roof panels with length of 48″ respectively (e.g., inserts are provided in the mould so that the cavity is smaller, such that when polymer flows into the cavity, the resulting piece has smaller dimensions than if the inserts were not provided in the cavity). According to an exemplary embodiment, all inserts start off the same size with different cavity seal-offs. All inserts would be accessible from the top side for quick changeovers.

The tools share a common base tool and to change from one roof panel embodiment to another embodiment only the insert tool needs to be replaced with a different respective insert tool. The insert tool may seal off a different amount of the tool to vary specific dimensions (e.g., length), meaning the base tool may be made to construct the largest roof panel and by adding inserts which either reduce size or modify geometry, additional variants are made from the same base tool. The use of insert tools reduces tooling costs and may be substituted without requiring a complete tool change over, thus making for a change over which requires less labor taking less time. FIGS. 10-12 show tool inserts that manufacture roof panels of 48″, 60″ and 72″ length, but the number of variants is flexible as are the dimensions flexible and not limited to that which is illustrated.

According to other embodiments, multiple variants of roof panels are not limited to varying dimensional properties and may be made with different geometries to accommodate other components or features. For example, the use of insert tooling allows for the change over from a base roof panel to another roof panel that includes additional features (e.g., skylight, overhead lights) which would be optional upgrades for the customer.

According to an exemplary embodiment, various components of the assemblies 10, 100, 200, 300, 500 are formed from a composite material. For example, according to an exemplary embodiment, the floor assembly members, frame structure members, back assembly members, side assembly members, roof assembly members, walls, and door assemblies may be made of a glass or carbon fiber-reinforced resin (e.g., a polyurethane or acrylonitrile-butadiene-styrene (ABS) resin matrix material that includes fiberglass strands, mats, rovings, or the like embedded within the matrix material). According to other exemplary embodiments, a polyester or vinyl ester resin system may be used for the matrix material. According to other exemplary embodiments, the members, walls, assemblies, and panels may be made of alloys (e.g., steel, aluminum), or made from any combination of materials. Different types of reinforcement materials may also be used according to various exemplary embodiments. For example, according to an exemplary embodiment, both unidirectional and mat-type and/or chopped fiber reinforcements may be used within a single component. Any suitable polymeric resin (e.g., thermosetting or thermoplastic resins) and reinforcement material may be used according to various exemplary embodiments. It should also be noted that different components may be made of different materials (e.g., if one component requires more strength than another component, additional or different reinforcement materials and/or matrix materials may be used to provide enhanced strength and/or rigidity). The composite components may be individually manufactured using a pultrusion process according to an exemplary embodiment, although it should be understood that other processes such as extrusion, thermoforming, injection moulding, or other suitable processes may be used according to other exemplary embodiments.

One advantageous feature of using composite materials for the various components of the assemblies 10, 100, 200, 300, 500 is that the overall structure of the assemblies will be lighter than if the assemblies were made from materials such as metals. The reinforcement materials that are utilized within the composite materials may provide enhanced strength for the components that are suitable for the demands that will be placed on the assemblies.

One advantageous feature of the assemblies shown and described herein is that the manufacture and assembly of the assemblies may be relatively simple and inexpensive. In addition to the fact that the various components are formed of a lightweight and inexpensive composite polymeric materials, the dimensions of the structures may be altered having quick change-over times without the need to purchase separate tooling. For example, if a sleeper cab having different dimensions is required, the frame structure members can be manufactured using the same equipment and cut to length.

This dimensional flexibility may also be achieved by using different inserts in the core or cavity halves of moulds to reduce piece cost and tooling cost. This modularity improves the ability of a manufacturer of the assemblies to respond to customer requirements in a relatively quick and efficient manner, without the need to redesign and purchase new tooling for the majority of the components of the assembly. This modularity also provides for a shorter validation period and less expensive validation process. Additionally, this modularity also provides for less expensive repairs for service.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the modular sleeper box as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

Those skilled in the art can now appreciate from the foregoing description that the broad teachings of the present invention can be implemented in a variety of forms. Therefore, while this invention has been described in connection with particular examples thereof, the true scope of the invention should not be so limited, since other modifications will become apparent to the skilled practitioner upon a study of the drawings, specification and following claims.

1. A modular roof assembly for a sleeper cab comprising:
a front outer panel;
a rear outer panel; and
a top outer panel connected to and extending between said front outer panel and said rear outer panel;
at least two side outer panels extending between and connected to said front outer panel, said rear outer panel and said top outer panel to form one closed side of said modular roof assembly; and
a channel formed by a gap between portions of said top outer panel and said rear outer panel for proving a support to said modular roof assembly, wherein said modular roof assembly is made of composite material and is configured to be connected to a sleeper cab.

2. The modular roof assembly of claim 1 further comprising one or more roof bows formed in said top outer panel and extending across said top outer panel between said at least two side panels for providing support to said modular roof assembly.

3. The modular roof assembly of claim 1 further comprises a side inner panel connected to a respective one of said at least two outer side panels.

4. The modular roof assembly of claim 1 further comprising a front inner panel connected to said front outer panel for providing additional support to said modular roof assembly.

5. The modular roof assembly of claim 1 further comprising a rear inner panel connected to said rear outer panel for providing additional support to said modular roof assembly.

6. The modular roof assembly of claim 1 further comprising:
a first set of one or more grooves formed between said front outer panel and said top outer panel and a rib extending into said one or more grooves for connecting said front outer panel and said top outer panel;
a second set of one or more grooves formed between said front outer panel and each respective one of said at least two side outer panels and a rib extending into said one or more grooves for connecting said front outer panel and each respective one of said at least two side panels;
a third set of one or more grooves formed between said rear outer panel and said top outer panel and a rib extending into said one or more grooves for connecting said front outer panel and said top outer panel;
a fourth set of one or more grooves formed between said rear outer panel and each respective one of said at least two side outer panels and a rib extending into said one or more grooves for connecting said rear outer panel and each respective one of said at least two side panels; and
a fifth set of one or more grooves formed between said top outer panel and each respective one of said at least two side outer panels and a rib extending into said one or more grooves for connecting said top outer panel and each respective one of said at least two side panels.

7. An interchangeable modular sleeping cab assembly system comprising:
a sleeper cab having selectable predetermined parameters, said sleeper cab being formed in part by two or more components each formed in a cavity of a molding tool, wherein said two or more components each have at least one dimension that defines the selectable predetermined parameters of said sleeper cab;
two or more alternate components formed in a cavity of said molding tool having an insert positioned in said cavity, wherein said two or more alternate components have at least one dimension that alters the selectable predetermined parameters of said sleeper cab when said sleeper cab is formed in part using said two or more alternate components in place of said two or more components.

8. The interchangeable modular sleeping cab assembly of claim 7 wherein said at least one dimension of said two or more components and said two or more alternate components is one or more of the following: length, width and height.

9. The interchangeable modular sleeping cab assembly of claim 7 wherein said selectable predetermined parameter of said sleeper cab is one or more of the following: length, width, volume, area and height.

10. The interchangeable modular sleeping cab assembly of claim 7 wherein said two or more components and said two or more alternate components are two or more of the following: a roof assembly, an outer side panel, a front outer panel, a roof outer panel, a rear outer panel, a frame structure, a floor assembly, a back assembly, and a side assembly.

11. A mould tool for forming components of an interchangeable modular sleeping cab assembly system comprising:
a mould tool having a cavity formed within said mould tool;
an interchangeable first insert positioned within said mould tool and creating part of said cavity, wherein said first insert and said mould tool define at least one parameter of said cavity to form a first component of said interchangeable modular sleeping cab when said first insert is place within said cavity;
an interchangeable second insert positioned within said mould tool and creating part of said cavity, wherein said second insert and said mould tool define at least one parameter of said cavity to form a second component of said interchangeable modular sleeping cab when said second insert is place within said cavity; and
an interchangeable third insert positioned within said mould tool and creating part of said cavity, wherein said third insert and said mould tool define at least one parameter of said cavity to form a third component of said interchangeable modular sleeping cab when said third insert is placed within said cavity, wherein said first component, said second component and said third component all have at least one dimension.

12. The mould tool of claim 11 wherein said at least one parameter of said cavity is one or more of the following: length, width, volume, area and height.

13. The mould tool of claim 11 wherein said at least one dimension is one or more of the following: length, width, volume, area and height

14. The interchangeable modular sleeping cab assembly of claim 11 wherein said first component, said second component and said third component are individually selected from one of the following: a roof assembly, an outer side panel, a front outer panel, a roof outer panel, a rear outer panel, a frame structure, a floor assembly, a back assembly, and a side assembly.

15. The interchangeable modular sleeping cab assembly of claim 11 wherein said first component, said second component and said third component are all roof assemblies having different lengths.
